(19) United States
(12) Patent Application Publication
(10) Pub. No.: US 2017/0043783 A1
(43) Pub. Date: Feb. 16, 2017

(54) VEHICLE CONTROL SYSTEM FOR IMPROVING OCCUPANT SAFETY

(71) Applicant: Faraday&Future Inc., Gardena, CA (US)

(72) Inventor: Hamed SHAW, Sunnyvale, CA (US)

(73) Assignee: Faraday&Future Inc., Gardena, CA (US)

(21) Appl. No.: 14/860,638

(22) Filed: Sep. 21, 2015

Related U.S. Application Data
(60) Provisional application No. 62/205,543, filed on Aug. 14, 2015.

(51) Int. Cl. B60W 40/08; B60H 1/00; B60N 2/00

(52) U.S. Cl. CPC B60W 40/08; B60N 2/002; B60H 1/00742; B60W 2040/0881

(57) ABSTRACT

The present disclosure is directed to a system of a vehicle for improving occupant safety. The system may include a camera configured to capture an image of an interior of the vehicle and responsively generate a signal, and a controller in communication with the camera. The controller may be configured to receive the signal from the camera, determine that the vehicle is occupied based on the signal, and generate and send an alert to a communication device based on the vehicle being occupied.

### CROSS REFERENCE TO RELATED APPLICATIONS

This application claims the benefit of priority based on U.S. Provisional Patent Application No. 62/205,543 filed on Aug. 14, 2015, the entire disclosure of which is incorporated by reference.

### TECHNICAL FIELD

The present disclosure relates generally to a control system for a vehicle, and more particularly, to a vehicle control system for improving occupant safety.

### BACKGROUND

There have been numerous incidents of adults unintentionally placing a child in danger by leaving the child in a parked vehicle. This is often the result of the adult being in a hurry, lacking sleep, or not understanding the consequences. The problem may also be caused by the placement of the child out of sight in the back seat of the vehicle. The situation may go unresolved until the adult realizes the mistake since the child may be unable to exit the vehicle, and pedestrians may not notice the child in the vehicle.

The situation may compromise the health and safety of the child by creating a dangerous situation. Because of a lack of ventilation, the vehicle can reach up to 110° Fahrenheit (F.) even when the outside temperature is as low as 57° F. The danger is especially high during the summer months, when extreme outside temperatures may cause the interior of the vehicle to rise as much as 20° F. in 10 minutes. The extreme temperatures may therefore cause injury to the child within minutes of leaving them in a parked vehicle.

The disclosed control system is directed to overcoming one or more of the problems set forth above and/or other problems in the prior art, and to providing an improved vehicle system for improving the safety of people in the car.

### SUMMARY

One aspect of the present disclosure is directed to a control system for a vehicle for improving occupant safety. The control system may include a camera configured to capture an image of an interior of the vehicle and responsively generate a signal, and a controller in communication with the camera. The controller may be configured to receive the signal from the camera, determine that the vehicle is occupied based on the signal, and generate and send an alert to a communication device based on the vehicle being occupied.

Another aspect of the present disclosure is directed to a method of improving occupant safety. The method may include capturing an image of an interior of the vehicle and responsively generating a signal, and receiving the image in a controller. The method may also include determining that the vehicle is occupied based on the signal, and generating and sending an alert to a communication device based on the vehicle being occupied.

Yet another aspect of the present disclosure is directed to a vehicle. The vehicle may include a seat configured to accommodate a passenger, and a control system. The control system may include a camera configured to capture an image of an interior of the vehicle and responsively generate a signal, and a controller in communication with the camera. The controller may be configured to receive the signal from the camera, determine that the vehicle is occupied based on the signal, and generate and send an alert to a communication device based on the vehicle being occupied.

Still another aspect of the present disclosure is directed to a non-transitory computer-readable medium storing instructions which, when executed, cause one or more processors to perform a method of improving occupant safety. The method may include capturing an image of an interior of the vehicle and responsively generating a signal, and receiving the signal in a controller. The method may also include determining that the vehicle is occupied based on the signal, and generating and sending an alert to a communication device based on the vehicle being occupied.

### BRIEF DESCRIPTION OF THE DRAWINGS

FIG. 1 is a diagrammatic illustration of an exemplary embodiment of a vehicle interior;

FIG. 2 is a block diagram of an exemplary embodiment of a control system that may be used with the vehicle interior of FIG. 1; and

FIG. 3 is a flowchart illustrating an exemplary process that may be performed by the control system of FIG. 2.

### DETAILED DESCRIPTION

The disclosure is generally directed to a control system that may be implemented when a driver turns off and/or exits a vehicle. The control system may determine that the driver exited the vehicle (e.g., by detecting that the vehicle is shut down or locked) and that a child was left in the vehicle (e.g., by a camera detecting the face of the child). In some embodiments, the control system may be configured to send a text message to the driver as many as three times, and if the driver does not respond, the vehicle may then send a message to emergency responders. The camera system may also be configured to adjust the temperature in the vehicle by actuating a component of the vehicle.

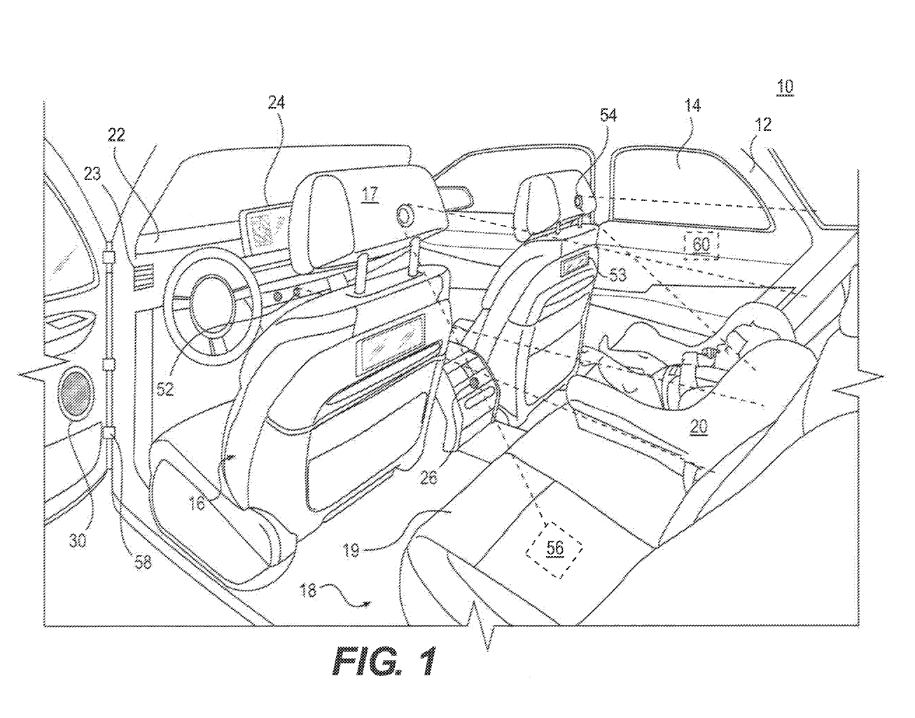

FIG. 1 provides a diagrammatic illustration of an exemplary vehicle interior according to an aspect of the disclosure. As illustrated in FIG. 1, a vehicle 10 may include, among other things, a number of doors 12 that may open and close, and a number of windows 14 that may be raised and lowered. Vehicle 10 may also include a pair of front seats 16 and one or more back seats 18. At least one of seats 16, 18 may accommodate a child car seat 20 to support an occupant of a younger age and/or smaller size. Vehicle 10 may also include a dashboard 22 having an environment control system including a number of vents 23, which allow passage of air from one or more fans, an air conditioning unit, and/or a heater (not shown). It is contemplated that vehicle 10 may be an electric vehicle, a fuel cell vehicle, a hybrid vehicle, or a conventional internal combustion engine vehicle. Vehicle 10 may have any body style, such as a sports car, a coupe, a sedan, a pick-up truck, a station wagon, a sports utility vehicle (SUV), a minivan, or a conversion van. Seats 16, 18 may be arranged in any number of rows. For example, back seat 18 may be in a second row of a sedan, or in a second and/or third row of a minivan or an SUV.

Vehicle 10 may also have various electronics installed to control the operation of the components, and transmit and receive data pertaining to their operation. For example, a door controller 58 may be configured to open and close each door 12, and/or generate a signal pertaining to the operation of each door 12. Similarly, a window controller 60 may be configured to raise and lower each window 14, and/or generate a signal pertaining to the operation of each window 14. Additional controllers may be operatively connected to components such as vents 23, a fan, an air conditioning unit, door locks, a transmission, a car alarm, and an engine battery. The controllers may include an actuator such as a motor configured to actuate each of the components and/or a sensor configured to generate a signal based on the status of each of the components.

Vehicle 10 may also have various electronics installed therein to transmit and receive data related to the presence of occupants and environmental conditions. For example, vehicle 10 may include a user interface 24 positioned in dashboard 22 and a microphone 26 positioned proximate back seat 18. Vehicle 10 may also include a display 53 and speakers 30 to transmit video and audio. Vehicle 10 may further include a weight sensor 56 positioned in a seat base 19 of each seat 16, 18. Vehicle 10 may even further include a variety of cameras in different locations and orientations, including a front camera 52 and a rear camera 54. As illustrated in FIG. 1, front camera 52 may be positioned in dashboard 22, and rear camera 54 may be positioned in back of a headrest 17 of front seats 16. It is contemplated that vehicle 10 may include any number of additional electronics to monitor the interior and control components of vehicle 10.

Front camera 52 and rear camera 54 may include any device configured to capture images or videos of the interior of vehicle 10. The images or videos may be processed to visually detect the presence of occupant(s) and environmental conditions of vehicle 10. For example, cameras 52, 54 may be used in conjunction with image recognition software, such that the software may distinguish a person from inanimate objects. The image recognition software may also be configured to detect characteristics of animals. Rear camera 54 may be directed fore and/or aft on any number of seats 16, 18 to increase the likelihood that rear camera 54 may be able to capture the facial features of occupants facing fore and aft. Vehicle 10 may also include cameras at a variety of other locations, such as, on a ceiling, doors, a floor, and/or other locations on seats 16, 18 in order to capture video or images of occupants of back seat 18. Vehicle 10 may, additionally or alternatively, include a dome camera configured to capture a 360° image of the interior of vehicle 10.

User interface 24 may be configured to receive input from the user and transmit data. User interface 24 may include an LCD, an LED, a plasma display, or any other type of display. User interface 24 may provide a Graphical User Interface (GUI) presented on the display for user input and data display. User interface 24 may further include a touchscreen, a keyboard, a mouse, or a tracker ball to enable user input. User interface 24 may be configured to receive user-defined settings. User interface 24 may transmit audio through speakers 30 and/or separate speakers.

Microphone 26 may include any structure configured to capture audio and generate audio signals (e.g., recordings) of the interior of vehicle 10. As depicted in FIG. 1, microphone 26 may be positioned proximate back seat 18 in order to capture audio from occupants of back seat 18. Microphone 26 may, additionally or alternatively, be positioned in other locations throughout vehicle 10, such as on the back of front passenger seats 16, on the front of back passenger seats 18, and/or incorporated into child seat 20. Microphone 26 may be used in conjunction with voice recognition software, such that the software may identify a person's voice.

Weight sensor 56 may include any structure configured to generate a signal based on a weight placed on each seat 16, 18. As depicted in FIG. 1, weight sensor 56 may be incorporated within the interior of seats 16, 18. Weight sensor 56 may embody a strain gauge sensor configured to determine a change in resistance based on a weight. Weight sensor 56 may be incorporated into a support of seats 16, 18 or may be a separate component. For example, weight sensor 56 may be incorporated into child car seat 20.

Display 53 may be positioned on the back of each front seat 16 to output images, videos, and/or other types of visual media to passengers in back seat 18. Display 53 may include an LCD, an LED, a plasma display, or any other type of display. Display 53 may be enabled according to a number of different conditions and may be configured to display any type of visual media, such as movies or television shows. In some embodiments, display 53 may be operatively connected to weight sensor 56 in order to enable only displays 53 directly visible to (e.g., positioned in front of) the occupants of back seat 18.

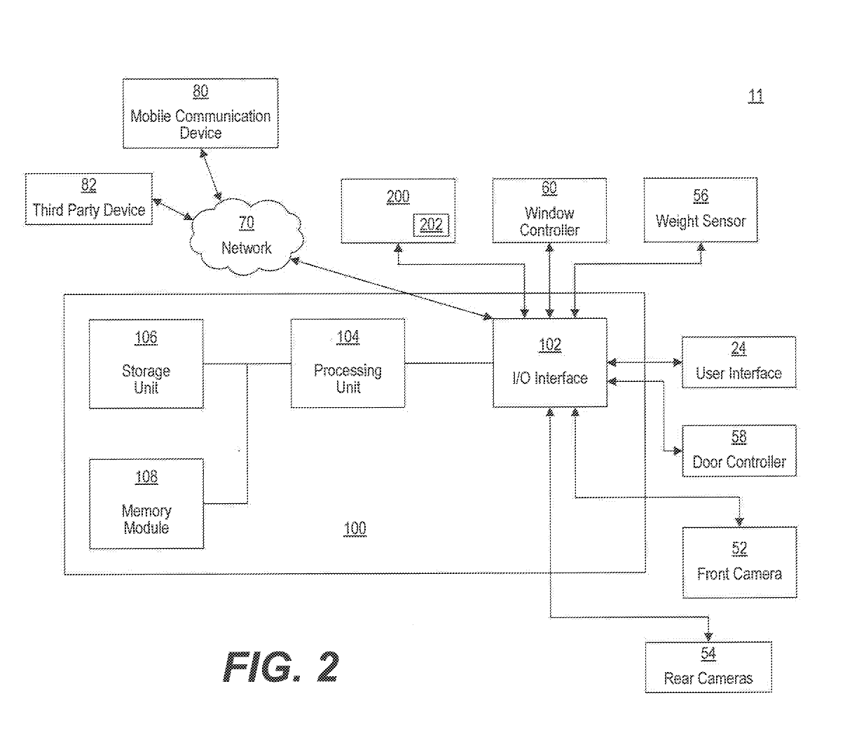

FIG. 2 provides a block diagram of an exemplary control system 11 that may be used to detect or monitor the occupants and control the environmental conditions of vehicle 10. As illustrated in FIG. 2, exemplary control system 11 may include a controller 100 having, among other things, an I/O interface 102, a processing unit 104, a storage unit 106, and/or a memory module 108. One or more of the components of controller 100 may be installed in an on-board computer of vehicle 10. These units may be configured to transfer data and send or receive instructions between or among each other.

I/O interface 102 may also be configured for two-way communication between controller 100 and various components of control system 11. For example, as depicted in FIG. 2, I/O interface 102 may send and receive operating signals to and from user interface 24, cameras 52, 54, door controller 58, window controller 60, and a variety of sensors, including weight sensor 56 and a status sensor 202. I/O interface 102 may send and receive the data between each of the components via communication cables, wireless networks, or other communication mediums.

Additionally, I/O interface 102 may be configured to transmit and receive data with, among other devices, a mobile communication device 80 and a third party device 82, over a network 70. Network 70 may be any type of wired or wireless network that may allow transmitting and receiving data. For example, network 70 may be a nationwide cellular network, a local wireless network (e.g., Bluetooth™ or WiFi), or a wired network. Mobile communication devices 80 and/or third party device 82 may also be configured to transmit geolocation data including geographic positioning data over network 70 to I/O interface 102, as later discussed in detail.

Mobile communication device 80 and third party devices 82 may be any type of communication device. For example, mobile communication device 80 and/or third party device 82 may include a smart phone with computing ability, a tablet, a personal computer, a wearable device, such as a smart watch or Google Glass™, and/or affiliated components. Third party device 82 may also include a communication device of another vehicle, a public system, and/or a communication device associated with a business.

One or more mobile communication devices 80 may be associated with people that are recognized by vehicle 10. For example, mobile communication devices 80 may be associated with the owners of vehicle 10, or other contacts (e.g., friends and family) of the owners of vehicle 10. In some embodiments, processer 104 may be configured to recognize one or more mobile communication devices 80 based on stored data in storage unit 106 and/or memory module 108. The stored data may include the person's name, the person's relationship with the owner vehicle 10, the person's contact information, and a digital signature of communication device 80. The digital signature of communication device 80 may be according to a determinative emitted radio frequency (RF), optical wireless communications (OWC) and/or a GPS tag. In some embodiments, one or more mobile communication devices 80 may be configured to automatically connect to controller 100 through local network 70 (e.g., Bluetooth™ Li-FI, and/or WiFi) when in proximity to (e.g., within) vehicle 10. Processing unit 104 may also be configured to enable geolocation tracking software, including GPS, on mobile communication device 80 when connected to network 70.

Third party devices 82 may be associated with additional people or organizations that may be contacted in case of emergency involving vehicle 10. For example, third party devices 82 may be associated with dispatchers of police departments, fire departments, hospitals and/or any other emergency responders. In some embodiments, third party device 82 may be associated with a general purpose emergency number (e.g., 911). It is contemplated that mobile communication devices 80 and/or third party devices 82 of control system 11 may be identified by geolocation and/or temporal aspects of response, as discussed later in detail.

Status sensor 202 may be operatively connected to vehicle 10 and configured to generate a signal to determine when a sufficient condition occurs to initiate operation of control system 11. The initiating condition may be based on a number of different parameters of vehicle 10. For example, status sensor 202 may be operatively connected to a power source 200, embodying at least one of an electric motor, a combustion engine, and/or a battery. In some embodiments, status sensor 202 may be configured to generate a signal to controller 100 when vehicle 10 is turned off. In some embodiments, status sensor 202 may be operatively connected to a transmission and configured to generate a signal when the transmission is placed into park. In some embodiments, status sensor 202 may be operatively connected to a speedometer and may be configured to generate a signal to controller 100 when vehicle 10 stops. In any sense, the initiating condition sensed by status sensor 202 may determine a time point of an initial inquiry of control system 11.

I/O interface 102 may be configured to consolidate signals that it receives from the various components and relay the data to processing unit 104. Processing unit 104 may include any appropriate type of general-purpose or special-purpose microprocessor, digital signal processor, or microcontroller. Processing unit 104 may be configured as a separate processor module dedicated to improving safety of the occupants. Alternatively, processing unit 104 may be configured as a shared processor module for performing other functions of vehicle 10 unrelated to improving safety of the occupants.

Processing unit 104 may be configured to receive signals from components of control system 11 and process the signals to determine a plurality of conditions of the operation of vehicle 10. Processing unit 104 may also be configured to generate and transmit command signals, via I/O interface 102, in order to actuate the components of control system 11.

For example, processing unit 104 may be configured to determine current occupancy and determine characteristics of the current occupants. For example, processing unit 104 may be configured to receive signals from at least one of weight sensor 56, door controller 58, cameras 52, 54, and/or mobile communication device 80, via I/O interface 102. In some embodiments, processing unit 104 may be configured to receive a weight signal generated by weight sensors 56 of each seat 16, 18. Based on the signals, processing unit 104 may be configured to compare the sensed weight to a stored threshold weight to determine if one or more of passenger seats 16, 18 are occupied. For example, if the weight sensed is less than the threshold weight, controller 100 may be configured to determine that seat 16, 18 is either unoccupied or is accommodating an object without sufficient weight to constitute a person. However, if the weight sensed is greater than the threshold weight, processing unit 104 may determine that a person is occupying seat 16, 18. Additionally, processing unit 104 may be configured to estimate an age of each of the occupants, by comparing the sensed weight with weights or ranges of weights associated with different ages. Processing unit 104 may also be configured to take into account the presence of other objects such as child car seats 20, the presence of which may be determined by at least one of an input via user interface 24, a characteristic weight determined weight sensor 26, and/or cameras 52, 54.

Processing unit 104 may, additionally or alternatively, be configured to determine current occupancy by receiving images from cameras 52, 54 and processing the images with image recognition software stored in storage unit 106 and/or memory module 108. In some embodiments, the image recognition software may include facial recognition software and may be configured to recognize facial features of the occupants. For example, processing unit 104 may be configured to compare the facial features with profile images stored in storage unit 106 and/or memory module 108 to determine an identity of the occupants. If the software does not recognize the identity or have a stored age for the occupant, the facial recognition software may additionally be configured to estimate the age, for example, by determining size and facial appearances. The age estimation may allow processing unit 104 to implement precautions for children occupants of vehicle 10. In some embodiments, facial recognition software may also be configured to recognize any physical ailments (e.g., by determining facial expressions, skin tone, and other physical indicators) of occupants based on the videos or the images. It is also contemplated that processing unit 104 may be configured to determine occupancy by receiving audio from microphone 26 and processing it with audio recognition software. Control system 11 may relay this data along with captured images, video, and/or audio to mobile communication device 80 and/or third party device 82.

Processing unit 104 may also be configured to determine whether the driver or other occupants have exited vehicle 10. For example, processing unit 104 may store the current occupancy data in storage unit 106 and/or memory module 108. Processing unit 104 may then, continuously or intermittently, recall and compare occupant data at subsequent time intervals to determine if at least one of the occupants has exited vehicle 10. Processing unit 104 may update the occupant data by a weight signal from weight sensor 56. Processing unit 104 may also be configured to determine a change in occupancy by receiving a signal from door controller 58 to determine when door 12 has opened and/or closed. In some embodiments, after a determination that door 12 has opened and closed, processing unit 104 may be configured to determine whether there was a change in occupancy by received weight signals from weight sensors 56. In some embodiments, processing unit 104 may be configured to determine when the driver or other occupants have exited vehicle 10 by processing images captured by cameras 52, 54.

Processing unit 104 may, additionally or alternatively, be configured to determine change in occupancy based on mobile communication device 80. For example, processing unit 104 may be configured to determine the location of mobile communication device 80 and generate a command signal when mobile communication device 80 travels a certain distance from vehicle 10. In some embodiments, the determination may be based on geolocation tracking of mobile communication device 80. For example, processing unit 104 may be configured to utilize geolocation software to received and record locations of mobile communication device 80. Processing unit 104 may also be configured to compare the geolocations of mobile communication device 80 to a geolocation of vehicle 10 to determine any separation. In some embodiments, processing unit 104 may be configured to make the determination based on when mobile communication device 80 is out of range of a local network 70, such as Bluetooth™, Li-Fi, and/or WiFi. For example, when mobile communication device 80 is no longer connected to local network 70, processing unit 104 may be configured to generate a command signal. In some embodiments, the determination may be based on the controller 100 reception of an RF signal emitted by mobile communication device 80.

In some embodiments, processing unit 104 may also be configured to output a video or an image as a reminder of an occupant (e.g., a child) in back seat 18 to a driver exiting vehicle 10. For example, processing unit 104 may be configured to receive signals from a variety of sensors of vehicle 10, such as weight sensor 56 to determine whether a child remains in back seat 18. Processing unit 104 may also receive a signal from status sensor 202, to determine when one or more conditions occur to indicate that the driver may exit vehicle 10. Exemplary conditions may occur when vehicle 10 is turned off, vehicle 10 is placed in park, a seat belt has been unbuckled, and/or door 12 of vehicle 10 is opened. Processing unit 104 may then automatically actuate rear camera 54, corresponding to the sensed child, to capture a video or an image of the child that the driver may not otherwise be aware of at the time. Processing unit 104 may then output the video or the image to user interface 24 and/or audio through speakers 30 as a reminder to the driver. Based on the determination that a child remains in back seat 18, processing unit 104 may, additionally or alternatively, initiate other visual or audio warnings to alert the driver and/or other passengers. For example, processing unit 104 may initiate an indicator light on dashboard 22 and/or a verbal indication through speakers 30.

Processing unit 104 may also be configured to transmit an alert to mobile communication device 80 and/or third party devices 82. For example, processing unit 104 may be configured to send messages indicating the conditions of the occupant(s) and/or vehicle 10. The messages may include the information, such as the time at which the occupant was left unattended, the temperature of interior of vehicle 10, and/or any determined conditions of the occupant. Processing unit 104 may also be configured to send video or images captured by cameras 52, 54 and/or audio captured by microphone 26. The video, images, and/or audio may allow the user of mobile communication device 80 and/or third party devices 82 to determine the health of the occupant.

Processing unit 104 may also be configured to perform certain actions based on the degree of danger of the situation. For example, based on the conditions, processing unit 104 may be configured to send an alert to one or more mobile communication devices 80 of a first group. Then, if processing unit 104 has not determined that the dangerous situation has been resolved within a proscribed period of time, processing unit 104 may then send an alert to one or more people of a second group of mobile communication devices 80, and so on. However, when dangerous conditions exist, processing unit 104 may be configured to elevate the response by contacting additional people. For instance, processing unit 104 may be configured to automatically contact a general emergency number (e.g., 911) when the temperature of interior of vehicle 10 reaches a certain temperature (e.g., about 85° F.).

Processing unit 104 may be configured to direct the alerts to mobile communication device 80 and/or third party devices 82 based on global positioning data. For example, processing unit 104 may direct the alerts to one or more mobile communication devices 80 within the closest proximity of vehicle 10. In some embodiments, processing unit 104 may then direct the alerts to one or more mobile communication devices outside of the closest proximity, if the one or more mobile communication devices 80 in the closest proximity have not responded within a proscribed period of time. For example, in embodiments where third party devices 82 are associated with emergency responders, processing unit 104 may be configured to query a database of global positioning of emergency responders. Processing unit 104 may direct the alerts to the emergency responders proximately positioned to vehicle 10. Similarly, processing unit 104 may be configured to query a database of addresses of police stations, fire departments, emergency rooms, and other responders to determine the responders most proximate to vehicle 10, and contact those units first. Generating the alert based on proximity would enhance responsiveness.

Processing unit 104 may also be configured to manipulate components of vehicle to increase the airflow and/or alter the interior temperature of vehicle 10. For example, processing unit 104 may be configured to initiate operation of an actuator, for example, to lower or raise one or more windows 14, or power one or more of a fan, an air conditioning unit, and a heater. Processing unit 104 may be configured to open or close vents 23 to allow air flow from the fan, the air conditioning unit, and/or the heater. Processing unit 104 may be configured to actuate door controllers 58 to unlock and/or open doors 12.

Additionally, processing unit 104 may be configured to interact with display 53. For example, processing unit 104 may display media, such as movies and/or music to entertain occupants of vehicle 10. The media may have a calming effect of occupants left unattended. Processor 104 may also output video and/or images to display 53 to allow a person to remotely interact with vehicle 10. The interaction with display 53 may further be in response to weight sensors 56, to enable only displays 53 directly visible to (e.g., positioned in front of) the occupants of back seat 18.

Storage unit 106 and memory module 108 may include any appropriate type of mass storage provided to store any type of information that processing unit 104 may need to operate. For example, storage unit 106 may include one or more hard disk devices, optical disk devices, or other storage devices to provide storage space. Memory module 108 may include one or more memory devices including, but not limited to, a ROM, a flash memory, a dynamic RAM, and a static RAM.

Storage unit 106 and/or memory module 108 may be configured to store one or more computer programs that may be executed by controller 100 to perform functions of control system 11. For example, storage unit 106 and/or memory module 108 may be configured to store software used by processing unit 104 to conduct image and/or voice recognition. Storage unit 106 and/or memory module 108 may be also configured to store information used by processing unit 104. For example, storage unit 106 may be configured to store data for individual profiles of common occupants (e.g., images and/or digital signatures of mobile communication devices 80) and/or other contacts (e.g., names, phone numbers of mobile communication devices 80, email addresses, and/or addresses). Storage unit 106 and/or memory module 108 may be further configured to store look-up tables used by processing unit 104. For example, storage unit 106 may be configured to store weight thresholds used to determine occupancy of each seat 16, 18.

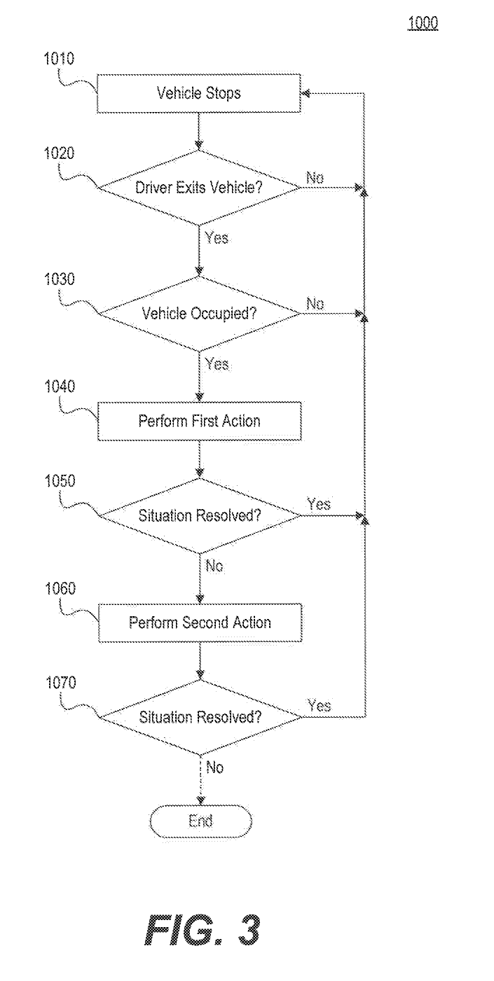

FIG. 3 illustrates an exemplary method 1000 performed by control system 11. The disclosed control system 11 may be used on any vehicle where an occupant may be left unattended. After determining the presence of the occupant, control system 11 may perform a number of different actions to alert people of the occupant, thereby improving the occupant's safety and/or provide a more habitable environment inside of the vehicle. In some embodiments, control system 100 may perform escalating steps based on results of previous steps or the danger of the situation. Operation of exemplary control system 11 will now be described with respect to FIG. 3.

In Step 1010, control system 11 may determine whether a condition occurs, to initiate operation of control system 11 to perform method 1000. As shown in FIG. 3, the initiating condition may be determined by a signal generated by status sensor 202 when vehicle 10 turns off. However, other initiating conditions are contemplated. In some embodiments, the initiating condition may occur when status sensor 202 determines that vehicle 10 is placed in park. In some embodiments, the initiating condition may occur when status sensor 202 determines that the speed of vehicle 10 reduces to a stop. The control system 11 may allow the driver to determine what constitutes an initiating condition discussed above, and to adjust the configuration based on stored settings. The initiating condition may signal to controller 100 to proceed to Step 1020.

In Step 1020, one or more components of control system 11 may determine whether a driver has exited vehicle 10. In some embodiments, the determination may be according to a weight signal generated by weight sensor 56 of front seat 16. In some embodiments, the determination may, additionally or alternatively, be made according to a door signal generated by door controller 58. In some embodiments, the determination may be based on detection of the location of mobile communication device 80 relative to vehicle 10. It is contemplated that controller 100 may continually determine the occupancy of vehicle 10, and store data pertaining to each of the occupants of vehicle 10. Controller 100 may therefore determine whether an occupant exits vehicle 10 in real-time and update the stored data based on the signal generated by at least one of weight sensor 56, door controller 58, and/or mobile communication device 80.

In Step 1030, one or more components of control system 11 may determine whether vehicle 10 is occupied following the driver exiting vehicle 10. In some embodiments, cameras 52, 54 may capture images of the interior of vehicle 10 and transmit them to controller 100. Controller 100 may then execute facial recognition software to recognize facial features of any occupants. Utilizing the facial recognition software, controller 100 may estimate the age of each of the occupants. In some embodiments, weight sensors 56 may determine the weight applied to each seat 16, 18 and transmit a weight signal to controller 100. Controller 100 may compare the weight signal to stored data to determine whether the weight signal is indicative of a person. Controller 100 may then compare the weight signal to stored data to estimate the age of the person. Alternatively, based on the initial weight signal, controller 100 may then actuate cameras 52, 54 and execute facial recognition software to determine if vehicle 10 is occupied by a person and determine the age of the person. It is contemplated that in some embodiments, Step 1030 may be based on a determination that the occupant is younger than a certain age (e.g., about 12 years old). However, in some embodiments, method 1000 may proceed (“Yes”; Step 1040) regardless of the age of the occupant(s).

In Step 1040, one or more components of control system 11 may perform a first action to resolve the situation. For example, controller 100 may send a message to one or more mobile communication devices 80. In some embodiments, controller 100 may contact mobile communication device 80 one or more times, and that the contact may be based on global positioning data. For example, controller 100 may have a plurality of stored contacts, and may contact a first mobile communication device 80 that is determined to be closest to vehicle 10. Controller 100 may subsequently contact other mobile communication devices 80 further from vehicle 10, depending on a response from first mobile communication device 80. It is contemplated that controller 100 may enable two-way communication between mobile communication device 80 and vehicle 10. For example, controller 100 may send images and/or video captured by cameras 52, 54 and audio captured by microphone 26 to mobile communication device 80. Controller 100 may also receive images, video, and/or audio from mobile communication device 80 and transmit it to display 53 and/or speakers 30. This exemplary two-way communication may allow interaction with the user of mobile communication device 80, the occupants of vehicle 10, and/or people that have already responded to the situation.

Controller 100 may also attempt to adjust the temperature of the interior of vehicle 10 by generating a command signal and directing it to components of vehicle 10. For example, controller 100 may direct a command signal to an actuator, such as window controller 60 in order to lower or raise one or more windows. Controller 100 may also generate a command signal to an actuator to power one or more of a fan, an air conditioning unit, and a heater. Controller 100 may further open or close vents 23 to allow air flow from the fan, the air conditioning unit, and/or the heater. In order to adjust the temperature in some embodiments, controller 100 may initiate power source 200 of vehicle 10.

In Step 1050, control system 11 may determine whether the situation has been resolved. In some embodiments, controller 100 may determine if a response was received from mobile communication device 80. For example, the determination may be based on the receipt of a message from mobile communication device 80. Controller 100 may also determine if mobile communication device 80 is sufficiently close to vehicle 10 to resolve the situation. Controller 100 may determine whether door controller 58 generates a door signal indicative of someone opening door 12. In some embodiments, controller 100 may determine if the interior temperature of vehicle 10 has reached a temperature range consistent with a comfortable environment. If at least one or more condition has not been satisfied (“No”; Step 1040), control system 11 may proceed to Step 1060.

In Step 1060, one or more components of control system 11 may perform a second action to resolve the situation. In some embodiments, controller 100 may send a message to third party device 82. For example, third party device 82 may be associated with emergency responders such as police departments, fire departments, hospitals, and/or any other emergency responders. In some embodiments, third party device 82 may be associated with a general purpose emergency number (e.g., 911). Controller 100 may also use global positioning data to determine the proximity of third party devices 82, and send a message to the closest third party devices 82. For example, controller 100 may determine the closest police department, fire department, hospital, and/or any other emergency responder, and send a message to that responder. It is also contemplated that controller 100 may send messages based on a database detailing the geolocation of registered emergency responders. Controller 100 may subsequently contact other third party devices 82 further from vehicle 10, depending on a response from first contacted third party devices 82.

In Step 1070, control system 11 may determine whether the situation has been resolved, similar to Step 1050. If not (“No”; Step 1070), control system 11 may progressively perform additional actions until the situation is resolved. For example, controller 100 may initiate operation of an actuator to sound a car alarm of vehicle 10 or open doors 12.

Another aspect of the disclosure is directed to a non-transitory computer-readable medium storing instructions which, when executed, cause one or more processors to perform the method of improving occupant safety, as discussed above. The computer-readable medium may include volatile or non-volatile, magnetic, semiconductor, tape, optical, removable, non-removable, and/or other types of computer-readable medium or computer-readable storage device. For example, the computer-readable medium may be storage 106 or memory module 108 having the computer instructions stored thereon, as disclosed in connection with FIG. 3. In some embodiments, the computer-readable medium may be a disc or a flash drive having the computer instructions stored thereon.

It will be apparent to those skilled in the art that various modifications and variations can be made to the disclosed control system. Other embodiments will be apparent to those skilled in the art from consideration of the specification and practice of the disclosed control system. It is intended that the specification and examples be considered as exemplary only, with a true scope being indicated by the following claims and their equivalents.

1. A control system for a vehicle for improving occupant safety, the control system comprising:
a camera configured to capture an image of an interior of the vehicle and responsively generate a signal; and
a controller in communication with the camera, the controller being configured to:
receive the signal from the camera;
determine that the vehicle is occupied based on the signal; and
generate and send an alert to a mobile device based on the vehicle being occupied.

2. The control system of claim 1, further including a sensor configured to generate a signal based on a person exiting the vehicle,
wherein the controller is configured to:
receive the signal from the sensor;
determine whether the person has exited the vehicle; and
actuate the camera based on the person having exited the vehicle.

3. The control system of claim 2, wherein the sensor is operatively connected to a driver side door.

4. The control system of claim 2, wherein the sensor is a weight sensor operatively connected to a driver seat.

5. The control system of claim 1, wherein the camera is configured to capture a video, and
wherein the controller is configured to send a signal indicative of the video to the mobile device to be displayed.

6. The control system of claim 1, further including a microphone configured to capture audio from the interior of the vehicle, and
wherein the controller is configured to send a signal indicative of the audio to the mobile device.

7. The control system of claim 1, further including an actuator configured to adjust a temperature of the interior of the vehicle, and
wherein the controller is configured to generate a command signal directed to the actuator to adjust the temperature of the interior of the vehicle based on the vehicle being occupied.

8. The control system of claim 7, wherein the actuator is configured to lower a window.

9. The control system of claim 7, wherein the actuator is configured to power at least one of a fan, an air conditioning unit, and a heater.

10. A method of improving occupant safety in a vehicle, the method comprising:
capturing an image of an interior of the vehicle and responsively generating a signal;
receiving the signal in a controller;
determining that the vehicle is occupied based on the signal; and
generating and sending an alert to a mobile device based on the vehicle being occupied.

11. The method of claim 10, further including:
generating a signal by a sensor based on a person exiting the vehicle;
receiving the signal from the sensor in a controller;
determining whether the person has exited the vehicle; and
actuating the camera based on the person having exited the vehicle.

12. The method of claim 11, wherein the sensor is a door sensor, and the signal from the door sensor is based on the closing of a door.

13. The method of claim 11, wherein the sensor is a weight sensor, and the signal is generated by the weight sensor is based on a change in weight applied to a driver seat.

14. The method of claim 10, further including capturing a video from the interior of the vehicle and sending a signal indicative of the video to the mobile device to be displayed.

15. The method of claim 10, further including capturing audio from the interior of the vehicle and sending a signal indicative of the audio to the mobile device.

16. The method of claim 10, further including:
generating a command signal to initiate an operation of an actuator; and
adjusting a temperature of the interior of the vehicle by operation of the actuator.

17. The method of claim 10, further including lowering a window based on the signal.

18. The method of claim 10, further including powering at least one of a fan, an air conditioning unit, and a heater.

19. A vehicle comprising:
a seat configured to accommodate a passenger; and
a control system comprising:
a camera configured to capture an image of an interior of the vehicle and responsively generate a signal;
an actuator configured to adjust a temperature of the interior of the vehicle; and
a controller in communication with the camera and the actuator, the controller being configured to:
receive the signal from the camera;
determine that the vehicle is occupied based on the signal; and
generate and send an alert to a mobile device based on the vehicle being occupied.

20. A non-transitory computer-readable medium storing instructions which, when executed, cause one or more processors to perform a method improving occupant safety of a vehicle, comprising:
capturing an image of an interior of the vehicle and responsively generating a signal;
receiving the signal in a controller;
determining that the vehicle is occupied based on the signal; and
generating and sending an alert to a mobile device based on the vehicle being occupied.
